(19) United States
(12) Patent Application Publication
(10) Pub. No.: US 2011/0239205 A1
(43) Pub. Date: Sep. 29, 2011

(54) INFORMATION PROCESSING APPARATUS AND COMPUTER READABLE MEDIUM STORING PROGRAM

(75) Inventor: Taro YOSHIHAMA, Yokohama-shi (JP)

(73) Assignee: FUJI XEROX CO., LTD., Tokyo (JP)

(21) Appl. No.: 12/874,760

(22) Filed: Sep. 2, 2010

(30) Foreign Application Priority Data
Mar. 25, 2010 (JP) 2010-070172

(51) Int. Cl. G06F 9/44

(52) U.S. Cl. 717/168

(57) ABSTRACT

An information processing apparatus includes: a storage unit that stores update information on update of an application; and an update information reading unit that, when there is update not applied to the application, reads the update information stored in the storage unit, in correspondence with information on an operation with respect to the application updated with the update.

### CROSS-REFERENCE TO RELATED APPLICATIONS

This application is based on and claims priority under 35 USC 119 from Japanese Patent Application No. 2010-070172 filed Mar. 25, 2010.

### BACKGROUND

1. Technical Field

The present invention relates to an information processing apparatus and a computer readable medium storing a program.

2. Summary

According to an aspect of the present invention, there is provided an information processing apparatus including: a storage unit that stores update information on update of an application; and an update information reading unit that, when there is update not applied to the application, reads the update information stored in the storage unit, in correspondence with information on an operation with respect to the application updated with the update.

### BRIEF DESCRIPTION OF THE DRAWINGS

An exemplary embodiment of the present invention will be described in detail based on the following figures, wherein:

FIG. 1 illustrates an information processing system including client PCs as information processing apparatuses according to an exemplary embodiment of the present invention;

FIG. 2 illustrates a hardware configuration of the client PC;

FIG. 3 is a block diagram showing a configuration of an information processing program which operates on the client PC;

FIG. 4A is an example of a window displayed on a display or the like;

FIG. 4B is another example of the window displayed on the display or the like;

FIG. 4C is another example of the window displayed on the display or the like;

FIG. 5 is a table showing an example of application information;

FIG. 6 is a table showing timing to display update information;

FIG. 7 is a table showing an example of the update information; and

FIG. 8 is a flowchart showing an operation flow (S10) of the information processing program which operates on the client PC.

### DETAILED DESCRIPTION

Hereinbelow, an exemplary embodiment of the present invention will be described. Note that the following description is merely an example of implementation of the present invention and the present invention is not limited to the example described below but may be arbitrarily changed in accordance with necessity.

### [Information Processing System]

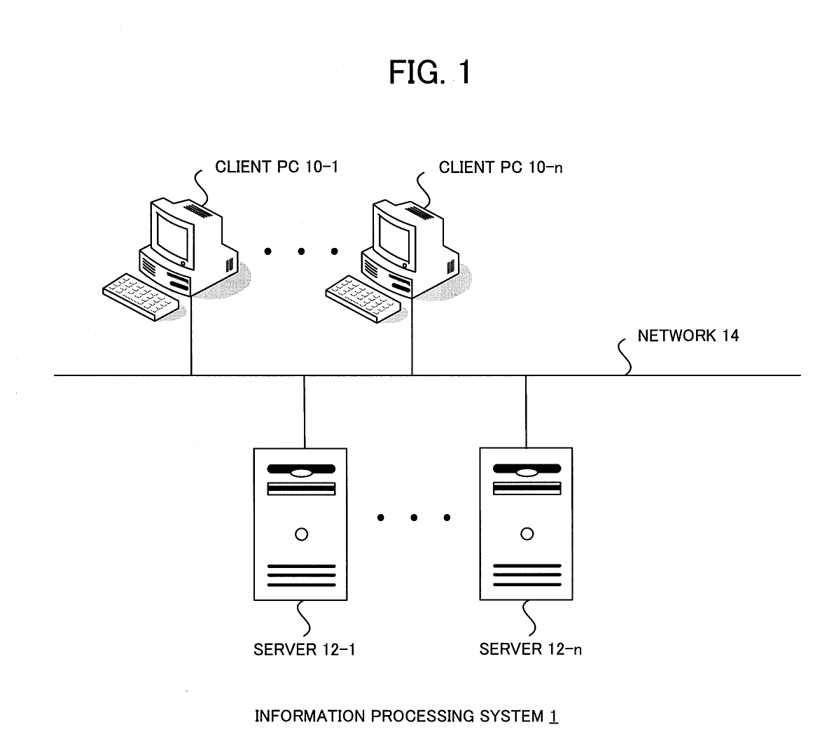

FIG. 1 illustrates an information processing system 1 including client PCs 10 as information processing apparatuses according to an exemplary embodiment of the present invention. As shown in FIG. 1, the information processing system 1 has client PCs 10-1 to 10-n and servers 12-1 to 12-n interconnected via a network 14.

The client PCs 10-1 to 10-n respectively have general computer functions for e.g. execution of an application. Note that the application means software designed for a particular purpose of e.g. document composition or numerical calculation such as Microsoft Office Word (registered trademark) or Microsoft Office Excel (registered trademark). In the exemplary embodiment, an information processing program to be described later is installed in the client PCs 10-1 to 10-n.

The servers 12-1 to 12-n store information on update and a module for update. “Update” means small-scale renewal of an application such as correction on a security problem found in the application or addition of a new function to the application. Hereinbelow, the information on update will be referred to as “update information”, and the module for update will be referred to as an “update module”. The update information will be described later.

The client PCs 10-1 to 10-n, respectively having the above configuration, download the update information and the update module from the servers 12-1 to 12-n.

Note that “n” is an integer equal to or greater than “1” and the integer “n” does not always indicate the same number.

In the following respective figures, substantially the same constituent elements have the same reference numerals.

Hereinbelow, when any one of plural constituent elements such as “client PCs 10-1 to 10-n” is given without being specified hereinbelow, it may be simply abbreviated to e.g. a “client PC 10”.

Although plural servers 12 are shown in FIG. 1, the number of the servers 12 may be one.

### [Client PC]

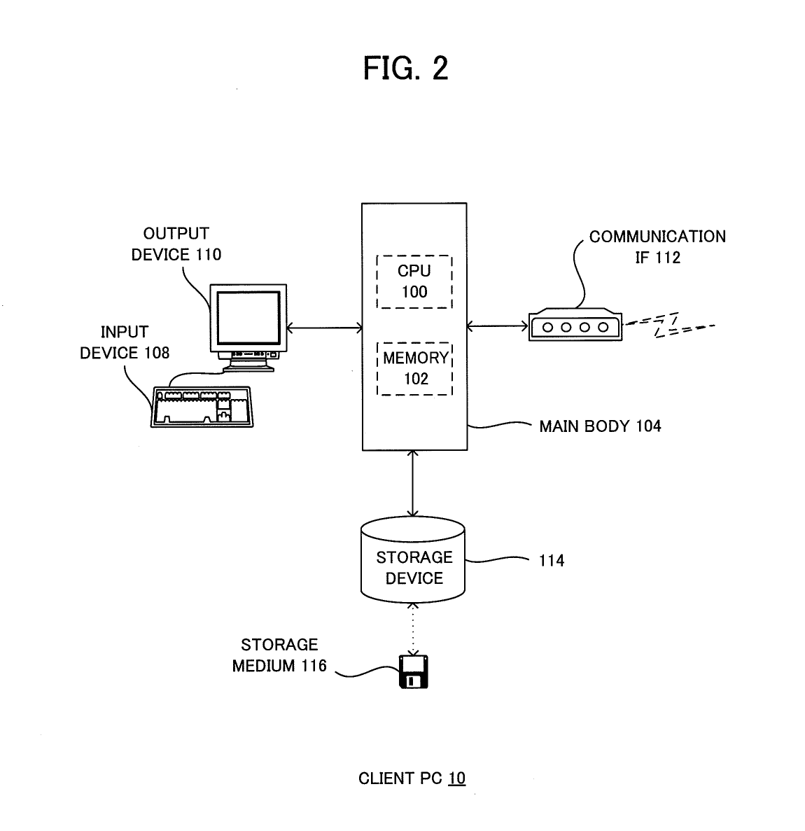

FIG. 2 illustrates a hardware configuration of the client PC 10 in FIG. 1.

As shown in FIG. 2, the client PC 10 has a main body 104 including a CPU 100, a memory 102 and the like, an input device 108, an output device 110, a communication interface (communication IF) 112, a storage device 114 and a storage medium 116.

That is, the client PC 10 has constituent elements as a computer capable of information processing and capable of communication with other devices.

The memory 102, the storage device 114 or the storage medium 116 stores software such as an application, an information processing program and an update module, and various information such as application information and update information. The application information and the update information will be described later.

The CPU 100 performs predetermined processing based on the information processing program stored in the memory 102, the storage device 114 or the storage medium 116, to control the operation of the client PC 10. The information processing program will be described later.

The input device 108 is a keyboard, a mouse, a joystick and the like. The output device 110 is a display device. Further, the storage device 114 is an HDD (Hard Disk Drive) or the like, and the storage medium 116 is a CD-ROM, a floppy disk (registered trademark) or the like.

### [Information Processing Program]

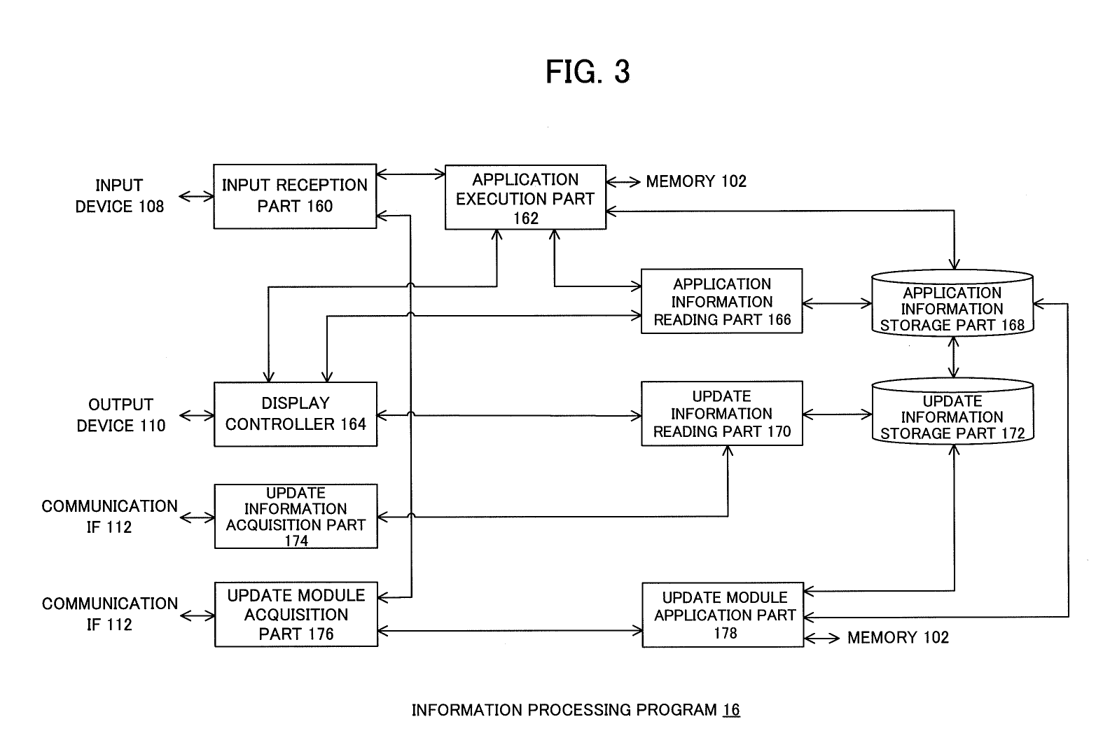

FIG. 3 is a block diagram showing a configuration of an information processing program 16 which operates on the client PC 10 in FIGS. 1 and 2.

As shown in FIG. 3, the information processing program 16 has an input reception part 160, an application execution part 162, a display controller 164, an application information reading part 166, an application information storage part 168, an update information reading part 170, an update information storage part 172, an update information acquisition part 174, an update module acquisition part 176 and an update module application part 178.

The information processing program 16 having the above configuration displays the update information in response to a user's operation and urges the user to apply the update module.

Hereinbelow, the components of the information processing program 16 and information stored in the components will be described with reference to FIGS. 3 to 7.

The input reception part 160 receives inputs for operations of an application (for example, starting of the application, execution of a function of the application and application/non-application of an update module) from the user via the input device 108 in FIG. 2.

When the operation of the input received by the input reception part 160 is starting of the application, the application execution part 162 reads the application stored in the memory 102 in FIG. 2 or the like and starts the application.

Further, when the operation of the input received by the input reception part 160 is execution of a function of the application, the application execution part 162 executes a corresponding function among the functions of the already-read application.

Note that when the application execution part 162 executes the function of the application, a value included in the application information stored in the application information storage part 168, indicative of the number of times of execution of the function of the application, is incremented.

When the application has been started by the application execution part 162 and when the function of the application is to be executed, the display controller 164 controls the output device 110 so as to display an application start-up screen and an application execution screen.

Further, in this case, the application information reading part 166 reads the application information from the application information storage part 168. Further, in correspondence with the read application information, the update information reading part 170 reads the update information from the update information storage part 172.

The display controller 164 controls the output device 110 in FIG. 2 so as to display the update information, in correspondence with the application information read by the application information reading part 166 and the update information read by the update information reading part 170.

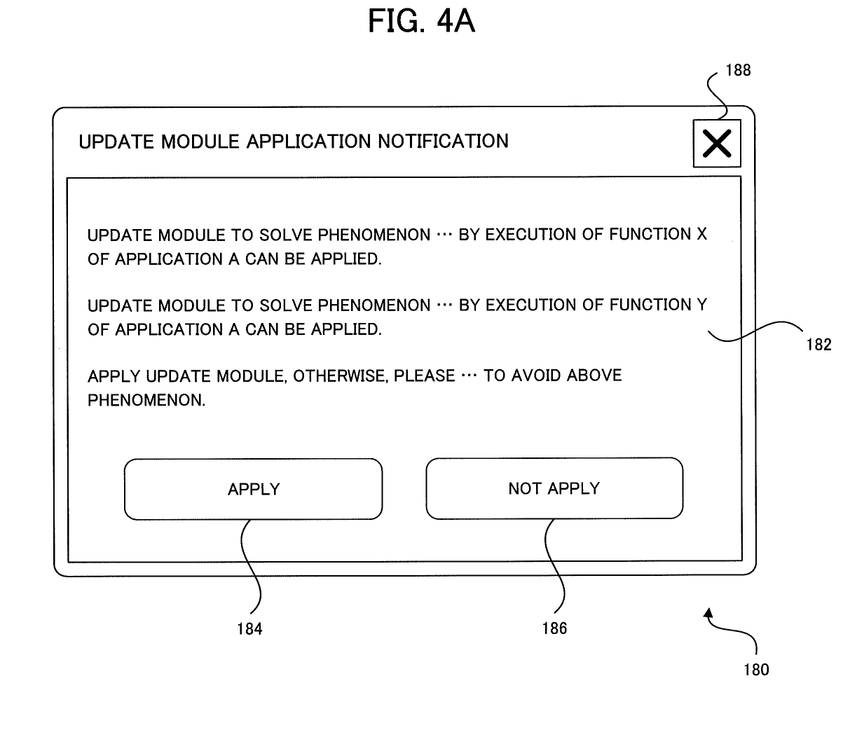

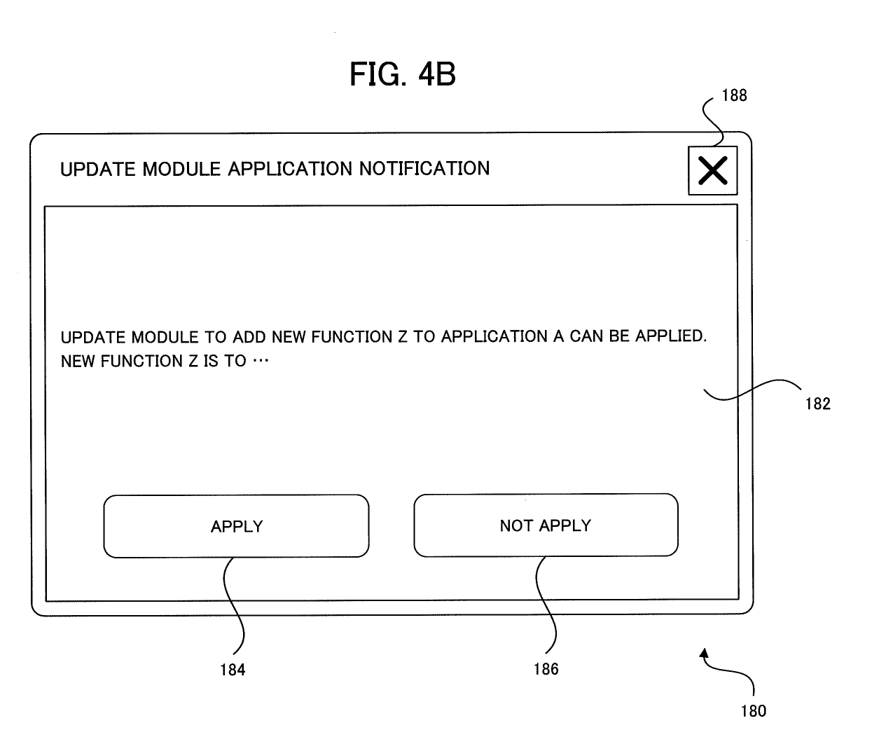

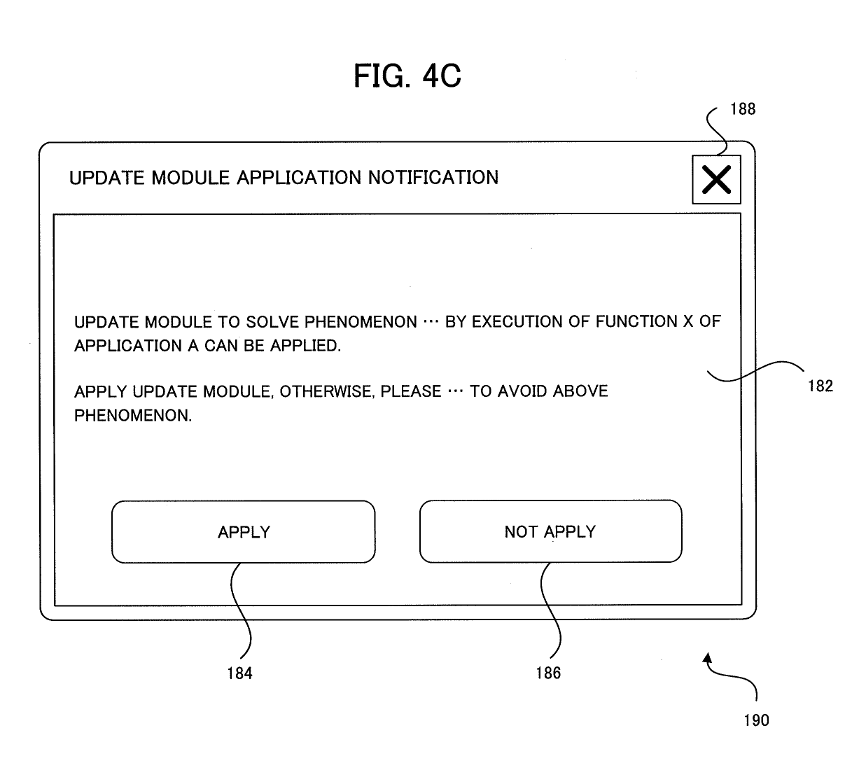

When the application has been started, the display controller 164 controls the output device 110 so as to display e.g. a window 180 shown in FIG. 4A, together with the application start-up screen. As shown in FIG. 4A, the window 180 includes an update information display 182 to display the update information (here, regarding functions X and Y of started application A, the update content and a procedure to avoid phenomena caused when the update module is not applied), an apply button 184 to apply the update module, a non-apply button 186 not to apply the update module, and a button 188 to close the window 180.

Note that it may be arranged such that, when the application has been started, the display controller 164 controls the output device 110 so as to display, e.g. the window 180 shown in FIG. 4B, together with the application start-up screen.

As shown in FIG. 4B, as the update information, information indicating that a new function Z can be added to the started application A and the content of the new function Z are displayed in the window 180.

When a cursor is placed on any one of the functions indicated in a pull-down menu of the application, the display controller 164 controls the output device 110 so as to display e.g. a window 190 shown in FIG. 4C, together with the application execution screen. As shown in FIG. 4C, the window 190 includes the update information display 182 to display the update information (here, regarding the function X on which the cursor is placed, the update content and the procedure to avoid the phenomenon caused when the update module is not applied), the apply button 184 to apply the update module, the non-apply button 186 not to apply the update module and the button 188 to close the window 190.

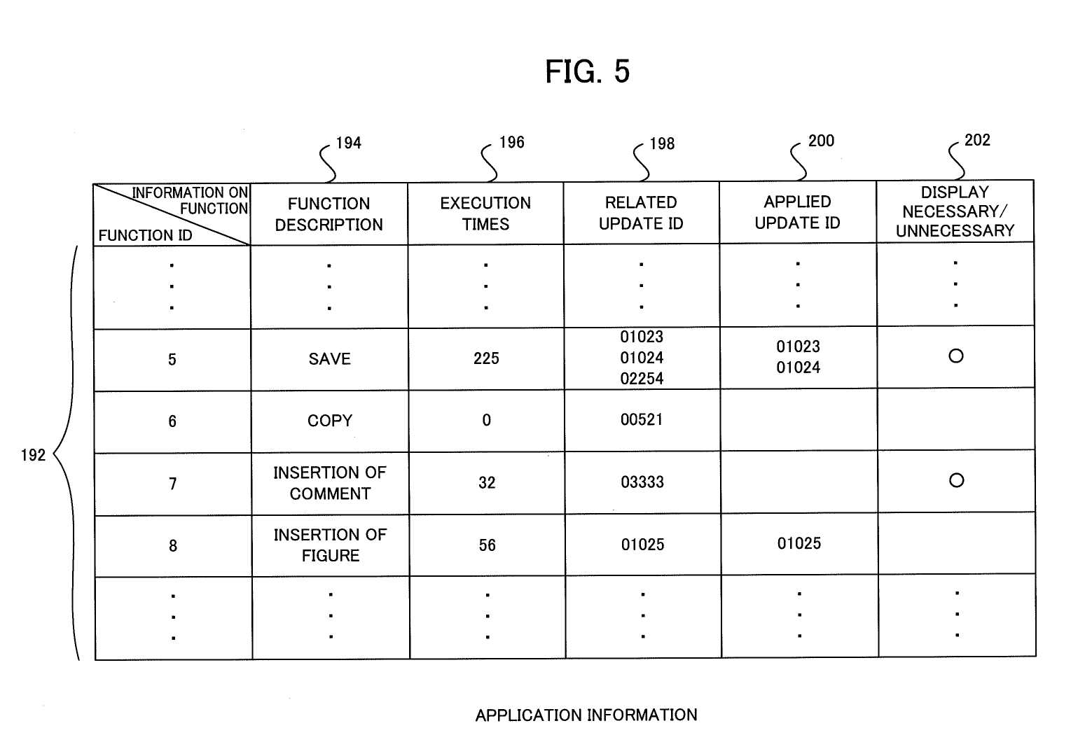

The application information is stored in the application information storage part 168 in e.g. the format shown in FIG. 5.

As shown in FIG. 5, the application information has information on each application function linked with each function ID 192. Here, the information on the application functions are function description 194, execution times 196, related update ID 198, applied update ID 200 and display necessary/unnecessary 202.

The function ID 192 is an identifier for identification of the application function.

The function description 194 indicates the content of the application function.

The execution times 196 indicates the number of times of execution of the application function. When the application function has been executed by the application execution part 162 in FIG. 3, the execution times 196 is incremented.

The update ID is an identifier for identification of an update module. The related update ID 198 is an ID of an update module related to the function identified with the function ID 192. The related update ID 198 is included in update information newly stored in the update information storage part 172 in FIG. 3, linked with a corresponding function ID 192.

The applied update ID 200 is an ID of an already-applied update module which has been applied by the update module application part 178 in FIG. 3 among the related update IDs in FIG. 3.

The display necessary/unnecessary 202 indicates whether or not the update information is to be displayed on the display or the like, in correspondence with information on application operation (for example, information on the number of times of execution of application function or information on unapplied update module).

For example, when the execution times 196 is equal to or greater than a previously determined (hereinbelow, “predetermined”) value and when it is found by referring to the related update ID 198 and the applied update ID 200 that there is an unapplied update module, the update information is displayed, otherwise, the update information is not displayed.

The display controller 164 in FIG. 3 reads the display necessary/unnecessary 202 from the application information, and controls the output device 110 in FIG. 2 based on the display necessary/unnecessary 202.

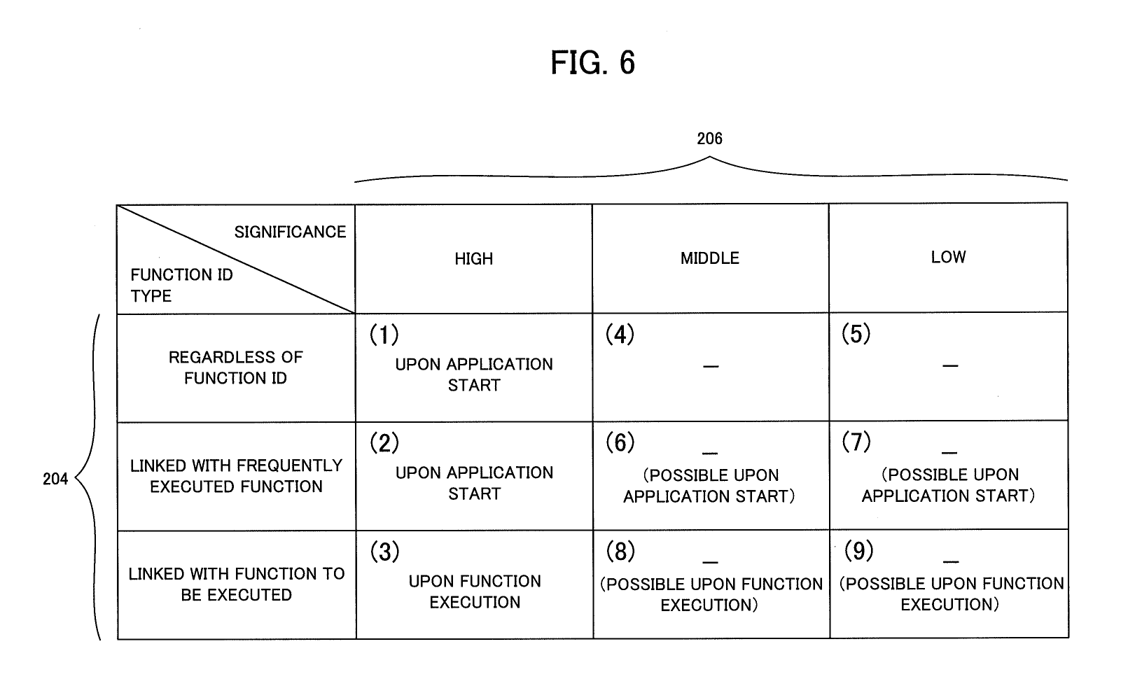

Further, when the update information is to be displayed, the display controller 164 determines timing to display the update information in correspondence with the application information and the update information. More particularly, the display controller 164 determines the display timing in correspondence with a function 204 linked with an unapplied update module and unapplied update module significance 206 shown in FIG. 6.

Note that the function 204 linked with an unapplied update module is acquired by referring to the application information, and the unapplied update module significance 206 is acquired by referring to the update information.

More particularly, as shown in (1) in FIG. 6, when the unapplied update module significance 206 is high, the update information is displayed upon starting of the application.

Further, as shown in (2) in FIG. 6, when the function ID 192 linked with an unapplied update module is linked with a frequently-executed function and when the unapplied update module significance 206 is high, the update information is displayed upon starting of the application.

As shown in (3) in FIG. 6, when the function ID 192 linked with an unapplied update module is linked with a function to be executed and when the unapplied update module significance 206 is high, the update information is displayed when the function is to be executed.

As shown in (4) and (5) in FIG. 6, when the unapplied update module significance 206 is at a middle or low level, the update information is not displayed.

AS shown in (6) and (7) in FIG. 6, when the function ID 192 linked with an unapplied update module is linked with a frequently-executed function and when the unapplied update module significance 206 is at a middle or low level, the update information is not displayed (the update information may be displayed upon starting of the application).

As shown in (8) and (9) in FIG. 6, when the function ID 192 linked with an unapplied update module is linked with a function to be executed and when the unapplied update module significance 206 is at a middle or low level, the update information is not displayed (the update information may be displayed when the function is to be executed).

Note that it may be arranged such that the timing is determined, not based on whether or not the function ID 192 linked with an unapplied update module is linked with a frequently-executed function, but based on whether or not the function ID 192 is linked with a function which has been executed.

Further, it may be arranged such that the timing is determined not based on the number of times of execution included in the application information, but by utilizing a log acquired by a log acquisition function or the like of the application.

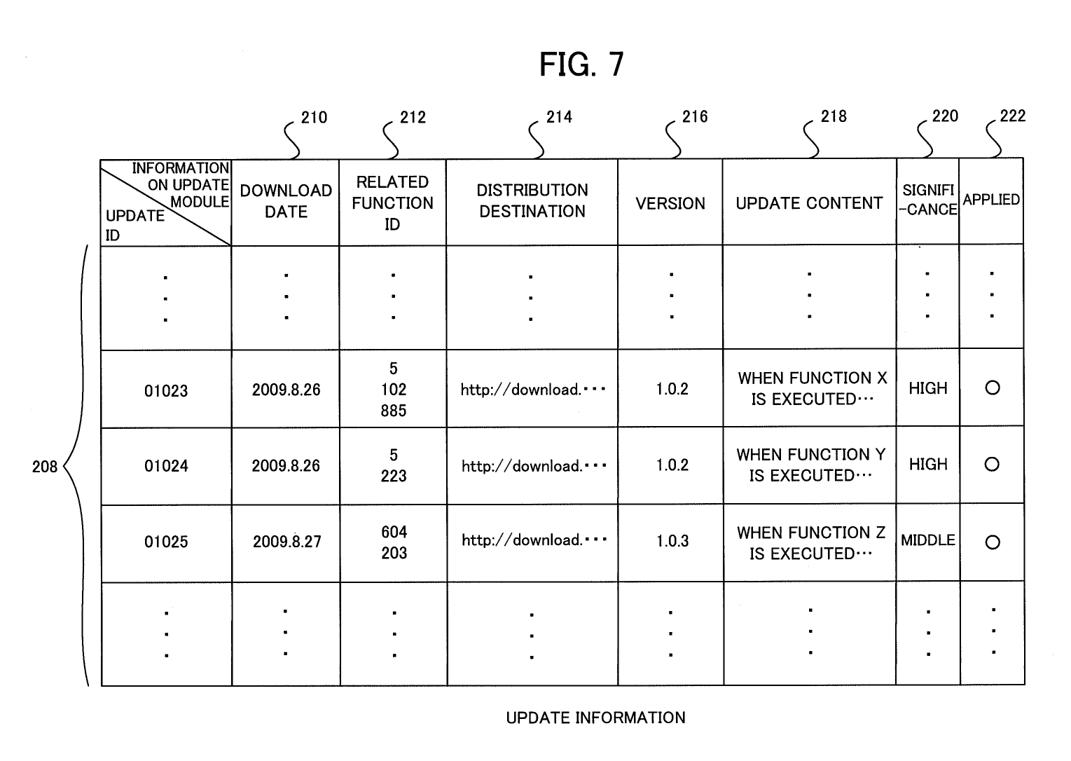

The update information is acquired by the update information acquisition part 174 in FIG. 3, at previously determined intervals, from the server in FIG. 1 via the communication IF 112 in FIG. 2. The update information is stored in the update information storage part 172 in FIG. 3 in e.g. the format shown in FIG. 7.

As shown in FIG. 7, the update information has information on each update module linked with each update ID 208. Here, the information on the update module is download date 210, related function ID 212, distribution destination 214, version 216, update content 218, significance 220 and applied 222.

The download date 210 indicates a date of download of the update module from a distribution destination.

The related function ID 212 is an ID of an application function related to the update module.

The distribution destination 214 indicates a distribution destination of the update module.

The version 216 indicates a version of the update module.

The update content 218 indicates content updated with the update module. Note that the update content 218 may include a procedure to avoid application of the update module.

The significance 220 indicates the significance of the update module.

The applied 222, which indicates whether or not the update module has been applied, is determined in correspondence with whether or not the update module application part 178 in FIG. 3 has applied the update module.

When an operation of an input received by the input reception part 160 in FIG. 3 is application of an update module, the update module acquisition part 176 in FIG. 3 acquires an update module from the server 12 in FIG. 1 via the communication IF 112 in FIG. 2.

The acquired update module is applied by the update module application part 178 in FIG. 3 to an application stored in the memory 102 in FIG. 2 or the like, and stored in the update information storage part 172 in FIG. 3.

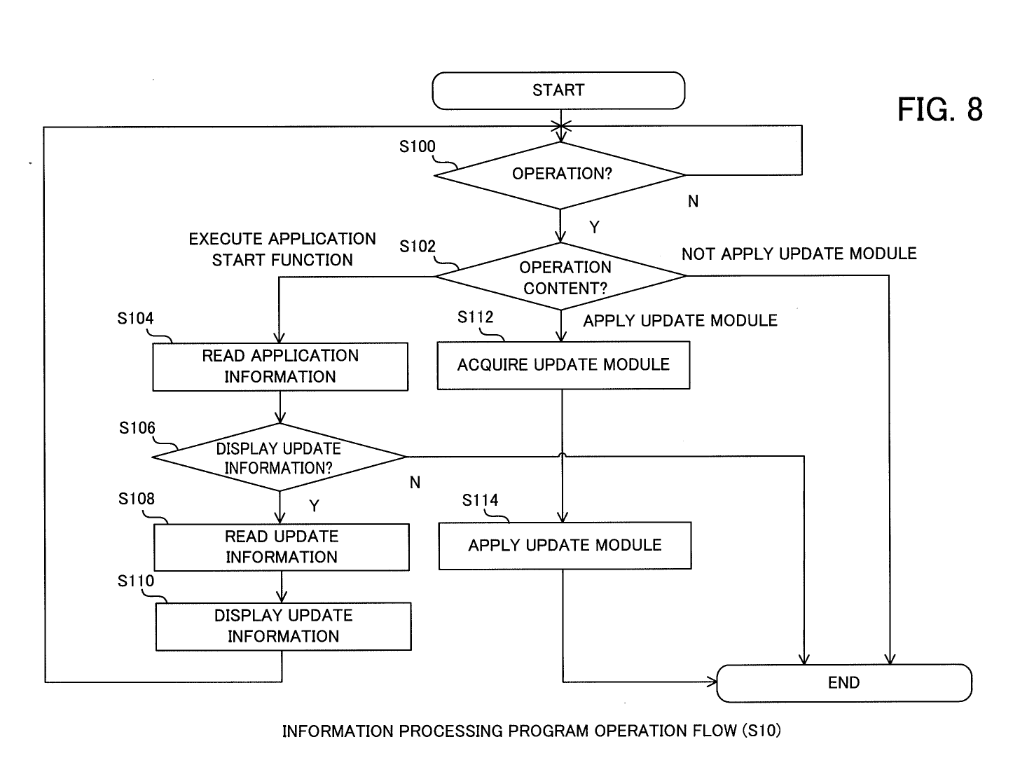

FIG. 8 is a flowchart showing an operation flow (S10) of the information processing program 16 which operates on the client PC 10 in FIG. 1.

As shown in FIG. 8, at step S100, it is determined whether or not the input reception part 160 in FIG. 3 has received an input of an operation of an application via the input device 108 in FIG. 2. When it is determined that an input of an operation has been received, the process proceeds to step S102, otherwise, the processing at step S100 is repeated.

At step S102, the application execution part 162 in FIG. 3 determines the content of the operation of the input received at step S100. When the content of the operation is starting of the application and execution of the function of the application, the process proceeds to step S104. When the content of the operation is application of an update module, the process proceeds to step S112. When the content of the operation is non-application of the update module, the process ends.

At step S104, the application information reading part 166 in FIG. 3 reads the application information from the application information storage part 168 in FIG. 3.

At step S106, the display controller 164 in FIG. 3 determines whether or not the update information is to be displayed based on the application information read at step S104. When the update information is to be displayed, the process proceeds to step S108, otherwise, the process ends.

At step S108, the update information reading part 170 in FIG. 3 reads the update information from the update information storage part 172 in FIG. 3.

At step S110, the display controller 164 determines timing to display the update information based on the application information read at step S104 and the update information read at step S108. The display controller 164 displays the update information at the determined timing, and the process returns to step S100.

At step S112, the update module acquisition part 176 in FIG. 3 acquires the update module from the server 12 in FIG. 1 via the communication IF 112 in FIG. 2.

At step S114, the update module application part 178 in FIG. 3 applies the update module acquired at step S112, to reflect the application of the update module on the application information referred to at step S104, and stores the update module acquired at step S112 in the update information storage part 172 in FIG. 3, and the process ends.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage unit that stores update information on update of an application; and
an update information reading unit that, when there is update not applied to the application, reads the update information stored in the storage unit, in correspondence with information on an operation with respect to the application updated with the update.

2. The information processing apparatus according to claim 1, wherein when there is update not applied to the application, the update information reading unit reads the update information in correspondence with whether or not a function of the application updated with the update has been executed a previously determined number of times or more.

3. The information processing apparatus according to claim 1, wherein when there is update not applied to the application, the update information reading unit reads update information on the update of the application in correspondence with significance of the update.

4. The information processing apparatus according to claim 1, wherein, when there is update not applied to the application, the update information reading unit reads update information on the update of the application when the application is started.

5. The information processing apparatus according to claim 1, wherein, when there is update not applied to the application, the update information reading unit reads update information on the update of the application when the application is to be started.

6. The information processing apparatus according to claim 1, wherein the update information includes update content of the application and a procedure to avoid a phenomenon caused when the update is not applied.

7. The information processing apparatus according to claim 1, further comprising an update information display that displays the update information read by the update information reading unit.

8. A computer readable medium storing a program causing a computer to execute a process for information processing, the process comprising:
storing update information on update of an application in a storage unit; and
when there is update not applied to the application, reading the update information stored in the storage unit, in correspondence with information on an operation with respect to the application updated with the update.
